(19) United States
(12) Patent Application Publication
(10) Pub. No.: US 2003/0135646 A1
(43) Pub. Date: Jul. 17, 2003

(54) Relay method for distributing packets to optimal server

(76) Inventors: Rumiko Inoue, Kawasaki (JP); Satoshi Tsuchiya, Kawasaki (JP); Koichi Takeda, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/201,475

(22) Filed: Jul. 23, 2002

(30) Foreign Application Priority Data
Jan. 11, 2002 (JP) 2002-004223

(51) Int. Cl. G06F 15/16

(52) U.S. Cl. 709/241; 709/245

(57) ABSTRACT

A relay method is provided. In the relay method, a relay apparatus receives a communication packet including a metric from a client, selects an optimal server on the basis of the metric by referring to a server table including server information including metrics of servers. Then, the relay apparatus sends the communication packet to the destination server indicated by the communication packet when the destination server is the optimal server, or, the relay apparatus sends, to the client, a destination changing packet for changing the destination server to the optimal server when the destination server is different from the optimal server.

### BACKGROUND OF THE INVENTION

1. Field of the Invention

The present invention relates to a relay method, and, a client, a server and a relay apparatus for the relay method. Especially, the present invention relates to a method for distributing and relaying packets received from the client, and, the client, the server and the relay apparatus for performing the method.

2. Description of the Related Art

As a conventional technology for server load balancing in a relay apparatus, a wide area load distribution function using a distribution algorithm and an HTTP redirect packet is known.

In the distribution algorithm, packets received from clients are distributed to servers according to a predetermined algorithm. When it is determined that, according to the distribution algorithm, a server of another site is suitable for processing the packets, a HTTP (Hyper Text Transfer Protocol) redirect packet including a URL (Uniform Resource Locator) of the server is sent to the client, and, then, the client accesses the server corresponding to the URL, so that wide area load distribution is realized.

In addition, there is a technology in which IP addresses are associated with actual geographical locations, and a server that is near the client is identified, so that a geographically optimal server is selected.

According to the conventional distribution algorithm, since a server to which packets are distributed is selected by using the predetermined algorithm, a demand of a client cannot be reflected to the algorithm. Thus, there is a problem in that the server is not optimally selected for the demands of the client. This problem occurs also in the technique in which a geographically near server is identified by using the IP address and the connection is redirected to the server.

### SUMMARY OF THE INVENTION

An object of the present invention is to provide a relay method for distributing packets sent from a client to an optimal server for the client, and to provide the client, the server and a relay apparatus used for the relay method.

The object of the present invention is achieved by a relay method including the steps of:

a relay apparatus receiving a communication packet including a metric from a client;

selecting an optimal server on the basis of the metric by referring to a server table including server information including metrics of servers;

sending the communication packet to a destination server indicated by the communication packet when the destination server is the optimal server;

sending, to the client, a destination changing packet for changing the destination server to the optimal server when the destination server is different from the optimal server.

According to the above invention, a desired metric for the user is included in a communication packet in the client, and the communication packet is sent. Thus, the relay apparatus that receives the communication packet can select an optimal server for the client on the basis of the metric, so that optimal packet distribution can be achieved.

### BRIEF DESCRIPTION OF THE DRAWINGS

Other objects, features and advantages of the present invention will become more apparent from the following detailed description when read in conjunction with the accompanying drawings, in which:

FIG. 1 shows a schematic diagram of a network system to which the present invention is applied;

FIG. 2 shows a block diagram of an embodiment of the relay apparatus of the present invention;

FIG. 3 shows a block diagram of an embodiment of a server to which the method of the present invention is applied;

FIG. 4 shows a block diagram of an embodiment of an client to which the method of the present invention is applied;

FIG. 5 shows a flowchart according to an embodiment of a packet receiving process performed by the relay apparatus;

FIG. 6 is a flowchart showing a server information request process performed by the relay apparatus 14 according to an embodiment;

FIG. 7 is a flowchart showing a server information notification process performed by each server according to an embodiment;

FIG. 8 is a flowchart showing a packet sending process performed by the client according to an embodiment;

FIG. 9 shows an embodiment of the server table 26 included in the relay apparatus;

FIG. 10 shows another example of the server table 26, which uses reliability as the metric;

FIG. 11 shows still another example of the server table 26, which uses @Nifty information as the metric;

FIG. 12 shows an embodiment of a communication packet sent by the client;

FIG. 13 shows a sequence of an embodiment of the method of the present invention;

FIG. 14 shows an embodiment of a server information notification packet sent by the server 16-18;

FIGS. 15A and 15B show examples of a display screen of the client.

### DETAILED DESCRIPTION OF THE PREFERRED EMBODIMENTS

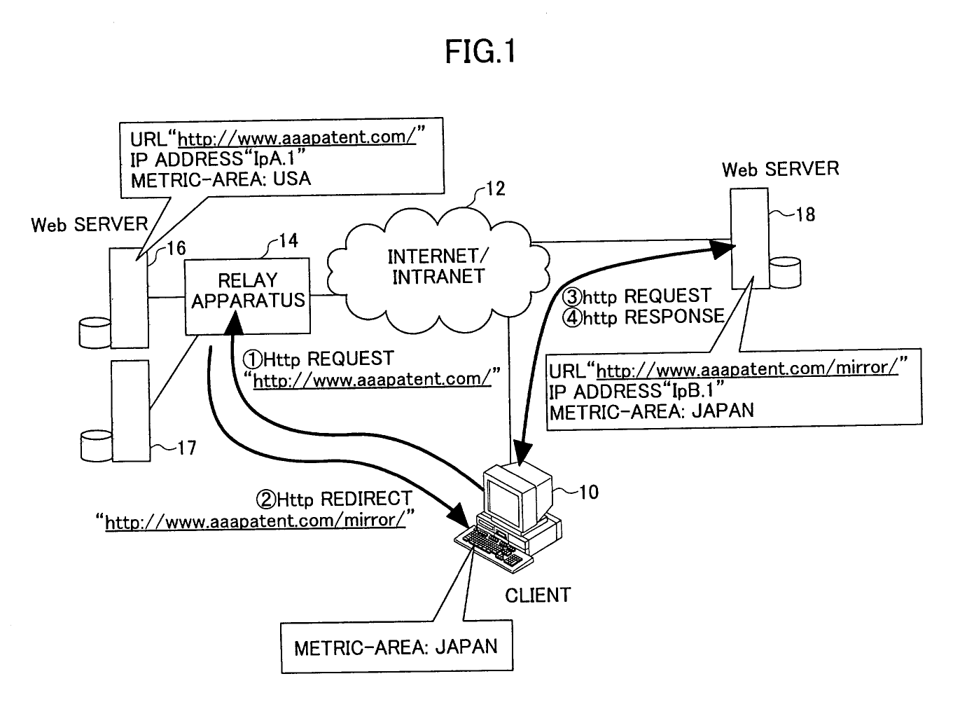

FIG. 1 shows a schematic diagram of a network system to which the present invention is applied. In the figure, a client 10 is connected to the Internet (or an intranet) 12. Servers 16, 17 (Web servers, for example) are connected to the Internet 12 (or an Intranet) via a relay apparatus 14. In addition, a server (Web server, for example) 18 is connected.

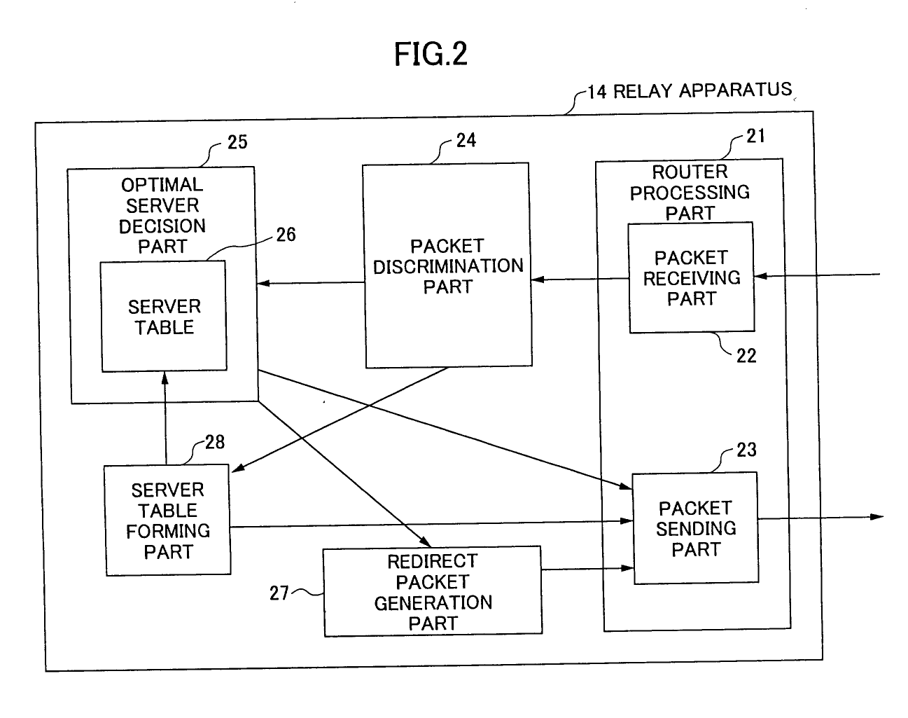

FIG. 2 shows a block diagram of an embodiment of the relay apparatus of the present invention. In the figure, the relay apparatus includes a router processing part 21, a packet discrimination part 24, an optimal server decision part 25, a redirect packet generation part 27 and a server table forming part 28.

The router processing part 21 is a part, which is also included in a conventional relay apparatus, for performing router processing. The router processing part 21 includes a packet receiving part 22 for performing receiving processes for a packet and a packet sending part 22 for performing sending processes for a packet.

The packet discrimination part 24 determines whether a received packet is a communication packet sent from a client or a server information notification packet sent from a server. The communication packet sent from a client is provided to the optimal server decision part 25, and the server information notification packet sent from the server is provided to the server table forming part 28.

The optimal server decision part 25 includes a server table 26. When the communication packet is provided, the optimal server decision part 25 decides an optimal server by referring to the server table 26. In the server table 26, server information on every server on the network 12 is stored.

The redirect packet generation part 27 generates an HTTP redirect packet when there is an instruction from the optimal server decision part 25. The server table forming part 28 collects server information on servers existing on the network 12 and stored the server information in the server table 26.

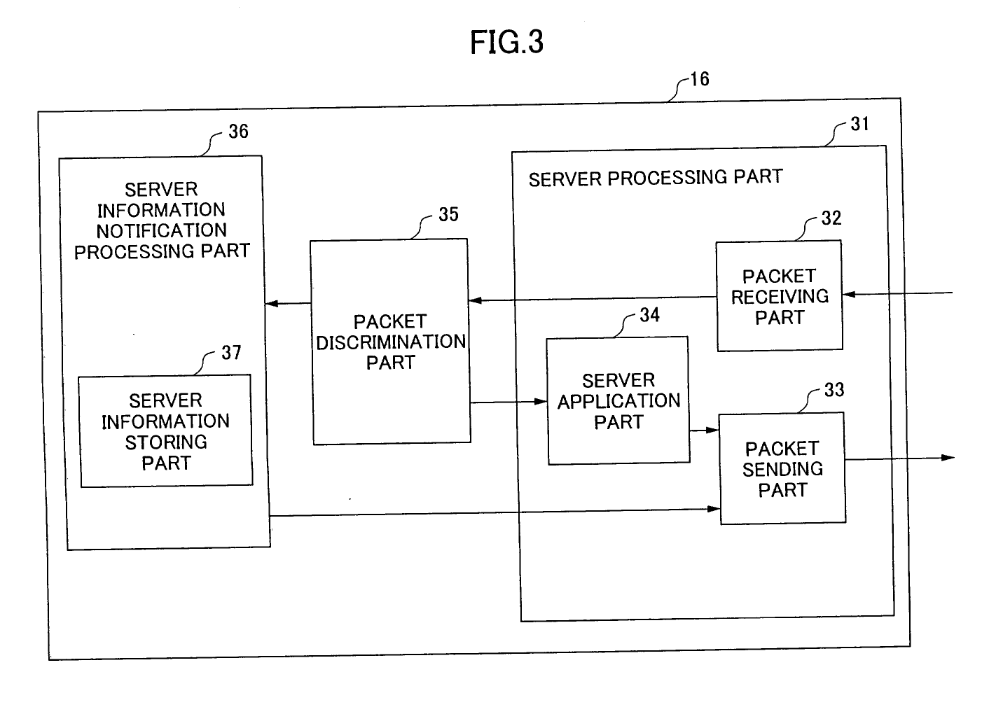

FIG. 3 shows a block diagram of an embodiment of a server to which the method of the present invention is applied. In the figure, the server 16 includes a server processing part 31, a packet discrimination part 35, and a server information notification processing part 36. The servers 17 and 18 have the same configuration as that of the server 16.

The server processing part 31 is a server processing part, which is also included in a conventional server. The server processing part 31 includes a packet receiving part 32 for performing receiving processes of a packet, a packet sending part 33 for performing sending processing of a packet and a server application part 34 for executing a server application.

The packet discrimination part 35 determines whether a received packet is a communication packet sent from a client or a server information request packet sent from the relay apparatus. The server information notification processing part 36 includes a server information storing part 37, which holds server information of the server itself and sends the server information to the relay apparatus 14.

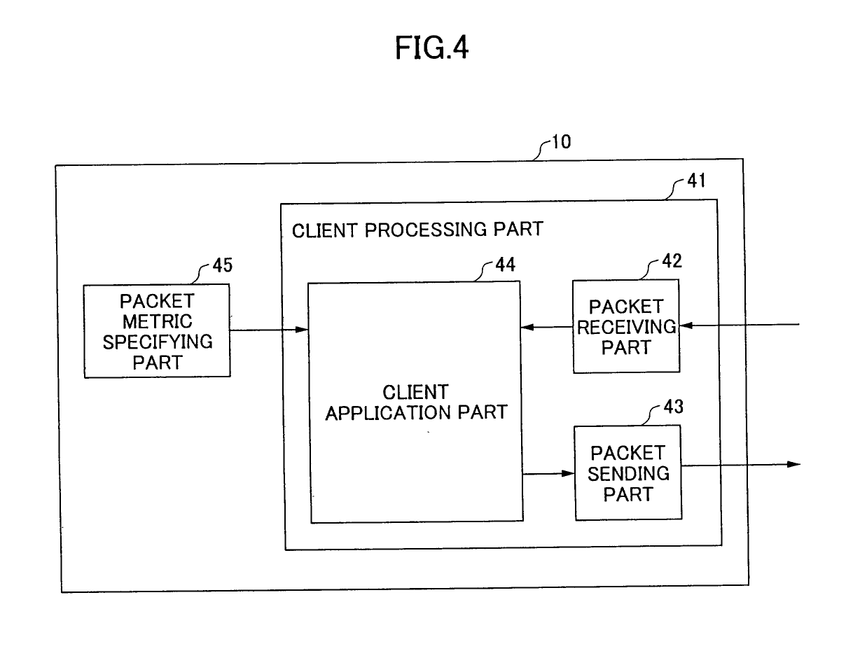

FIG. 4 shows a block diagram showing an embodiment of a client to which the method of the present invention is applied. The client 10 includes a client processing part 41 which performs conventional client processing and a metric specifying part 45.

The client processing part 41 includes a packet receiving part 42 for performing packet receiving processes, a packet sending part 43 for performing packet sending processes, and a client application part 44. The packet metric specifying part 45 sets metrics in packets.

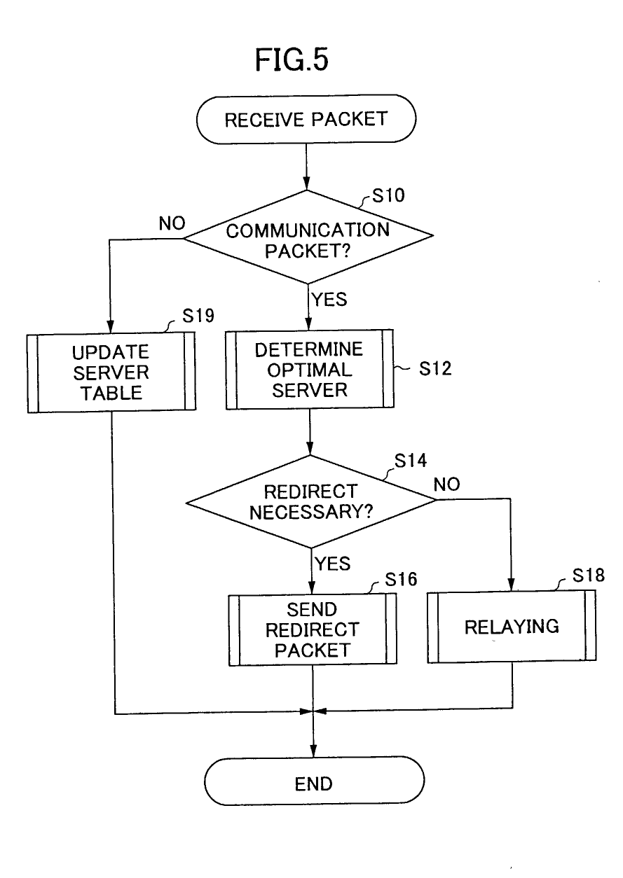

FIG. 5 shows a flowchart according to an example of the packet receiving process performed by the relay apparatus 14 This process starts by receiving a packet. First, the packet discrimination part 24 determines whether the received packet is a communication packet in step 10. When the packet is a communication packet, the optimal server decision part 25 determines an optimal server by referring to the server table 26 in step 12.

Next, the optimal server decision part 25 determines whether redirection is necessary in step 14. When redirection is necessary, the redirect packet generation part 27 generates a redirection packet and sends it to the client 10 in step 16. When redirection is not necessary, the received packet is sent to the server that is specified by the destination URL of the received packet.

When the packet is not the communication packet, the packet is a server information notification packet. The server table forming part 28 updates information in the server table 26 by using the server information notification packet in step 19.

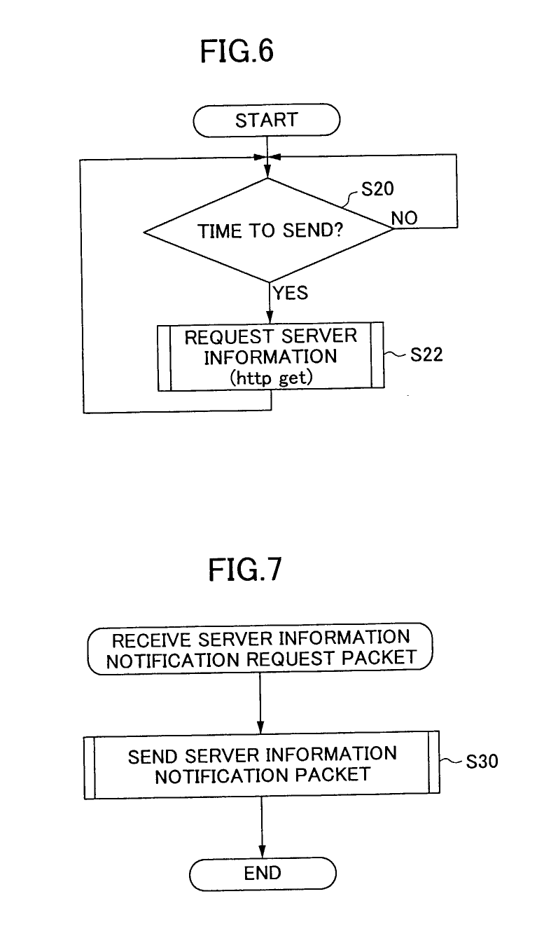

FIG. 6 is a flowchart showing a server information request process performed by the relay apparatus 14 according to an embodiment. First, the server table forming part 28 determines whether it is the time for sending a server information request in step 20, which arrives at predetermined intervals. When it is the time, the optimal server decision part 25 generates a server information request packet and sends it to each sever in step 22.

FIG. 7 is a flowchart showing a server information notification process performed by each server according to an embodiment. This process starts by receiving a server information request packet. The server information notification processing part 36 generates a server information notification packet from the sever information of the server itself in the server information storing part 37, and sends it to the relay apparatus 10 in step 30.

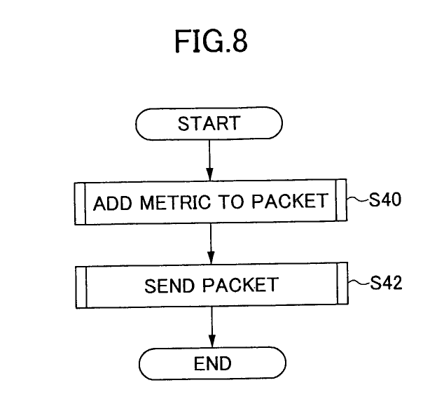

FIG. 8 is a flowchart showing a packet sending process performed by the client 10 according to an embodiment. This process is performed when sending a packet. The metric specifying part 45 specifies a metric, and the client application part 44 generates the communication packet to a server in which the metric is included in step 40. The packet sending part 43 sends the communication packet in step 42. This packet is received by the relay apparatus 14 via the Internet 12.

In the relay apparatus 14, the packet receiving part 22 receives the packet. The packet is determined to be a communication packet by the packet discrimination part 24. Then, the packet is passed to the optimal server decision part 25. The optimal server decision part 25 searches the server table 26 for the optimal server by using the destination URL and the metric included in the packet.

As a result of the search, when redirection is necessary, the packet is passed to the redirection packet generation part 27. The redirection packet generation part 27 generates an HTTP redirect packet including a URL of the determined optimal server. Then, the HTTP redirect packet is sent to the client 10 from the packet sending part 23.

In the client 10 that receives the HTTP redirect packet by the packet receiving part 42, the client application part 44 changes the destination URL of the packet to the URL specified by the relay apparatus 14, and the client resends the packet from the packet sending part 43.

In the relay apparatus 14, when redirection is not necessary as a result of the search, the packet is passed to the packet sending part 23, and the packet is relayed to the server (server 18, for example) specified by the destination URL included in the packet.

In the server that receives the packet by the packet receiving part 32, the packet discrimination part 35 determines that the packet is a communication packet, and the packet is passed to the server application part 34. The server application part 34 performs processes of the application, and returns a necessary packet to the client 10 from the packet sending part 33.

The server information request packet is generated every predetermined time in order to collect information of each server 16-18 automatically by the server table forming part 28 in the relay apparatus 14. The packet sending part 23 sends the server information request packet to each server.

In each server, the packet receiving part 32 receives the server information request packet. When the packet discrimination part 35 determines that the packet is a server information request packet, the packet is passed to the server information notification processing part 36. The server information notification processing part 36 generates a server information notification packet from the server information of the server itself in the server information storing part 37. Then, the server sends the packet from the packet sending part 33 to the relay apparatus 14.

The relay apparatus 14 receives the server information notification packet by using the packet receiving part 22. Then, the packet discrimination part 24 in the relay apparatus determines that the packet is a server information notification packet, and the packet is passed to the server table forming part 28. The server table forming part 28 updates information in the server table 26 by using the server information notification packet.

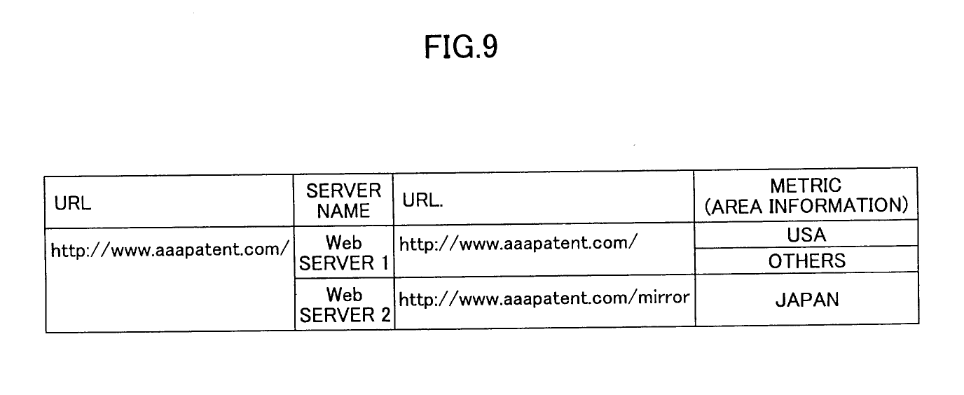

FIG. 9 shows an embodiment of the server table 26 included in the relay apparatus 14. In the server table 26 shown in FIG. 9, the following information is registered corresponding to a URL “http://www.aaapatent.com/” : the URL “http://www.aaapatent.com/” corresponding to a server name “Web server 1” and a metric (area information) “U.S.A., and others”, and, a URL “http://www.aaapatent-com/mirror” corresponding to a server name “Web server 2” and a metric (area information) “Japan”.

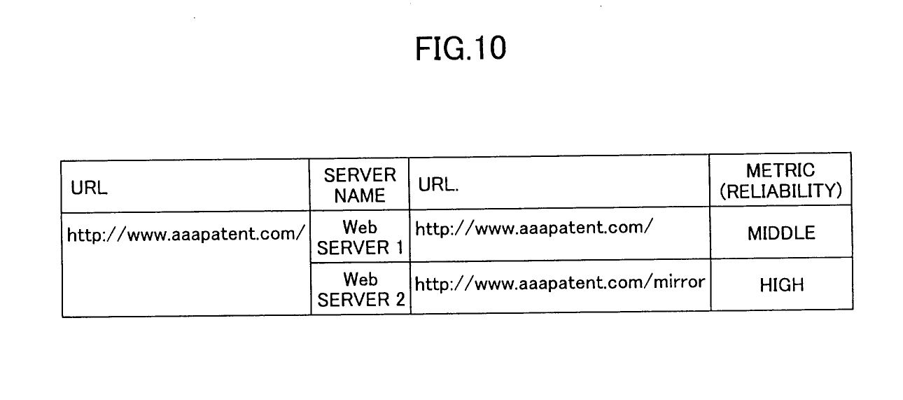

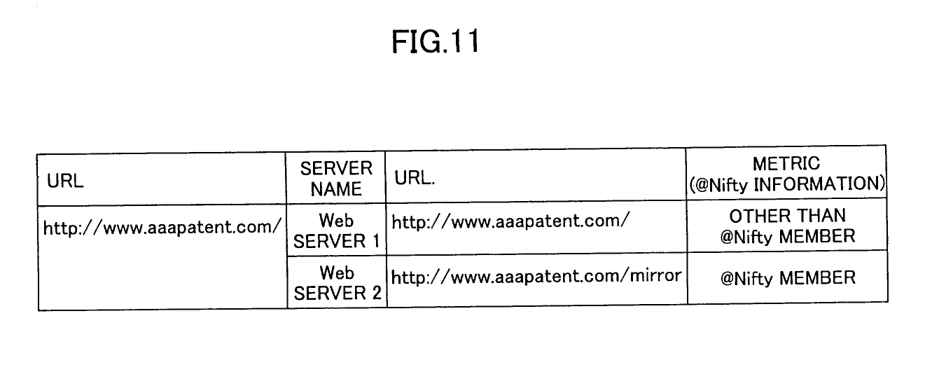

FIG. 10 shows another example of the server table 26, which uses reliability as the metric. FIG. 11 shows still another example of the server table 26, which uses @Nifty information as the metric. In addition, all kinds of the metrics shown in these figures can be included in the server table 26.

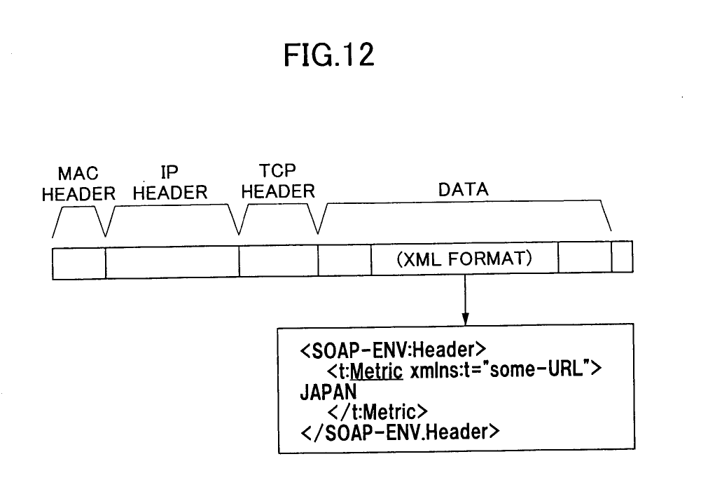

FIG. 12 shows an embodiment of the communication packet sent by the client 10. The communication packet includes a MAC header, an IP header, a TCP header and data. In this example, a metric “Japan” is included in the data in an XML (extensible Markup Language) format. As mentioned before, the metric may be area information specifying Japan, USA and the like, reliability, price, and various other information items.

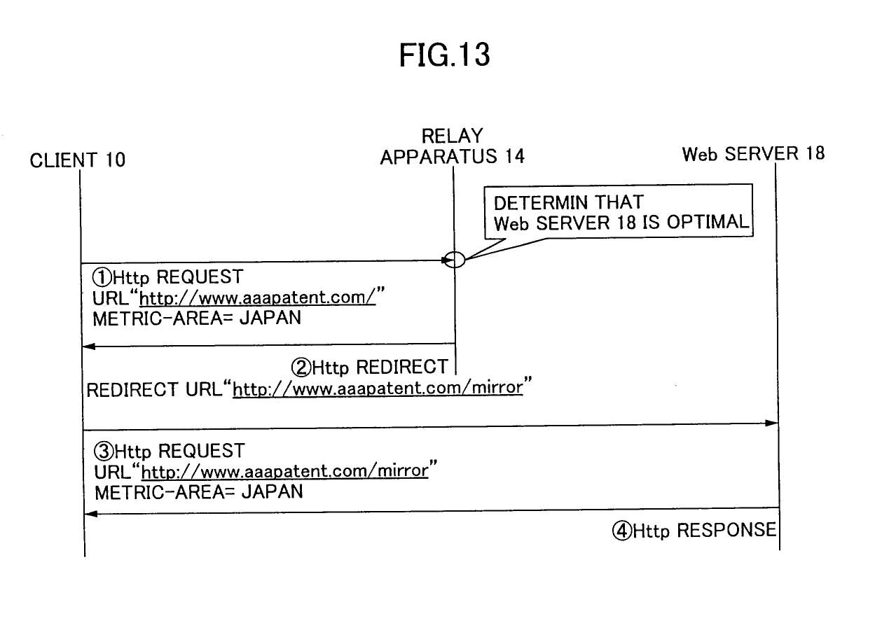

As shown in the sequence depicted in FIG. 13, the client 10 sends a communication packet as an HTTP request to the relay apparatus 14. The communication packet is destined for an IP address “IpA.1” corresponding to the URL: http://www.aaapatent.com/ in the server 16, and the packet includes a metric “Japan”. When the relay apparatus receives the communication packet, the relay apparatus 14 searches the server table 26 for an optimal server by using the URL included in the data in the packet and by comparing the metric in the packet with metrics in the server table 26.

When the server 16 accommodated by the relay apparatus 14 is not an optimal server, the relay apparatus 14 returns, to the client 10, an HTTP redirect packet including the URL: http://www.aaapatent.com/mirror of an optimal server (server 18, for example). When the server 16 is optimal, the relay apparatus relays the HTTP request to the server 16.

In this case, it is necessary to store the same content in both of the servers 16 and 18 such that same information can be obtained.

The client 10 that receives the HTTP redirect packet sends a packet as an HTTP request in which the URL is changed to “http://www.aaapatent.com/mirror” according to the instruction in the HTTP redirect packet. This changed HTTP request is sent to the server 18, and the server 18 sends an HTTP response to the client 10.

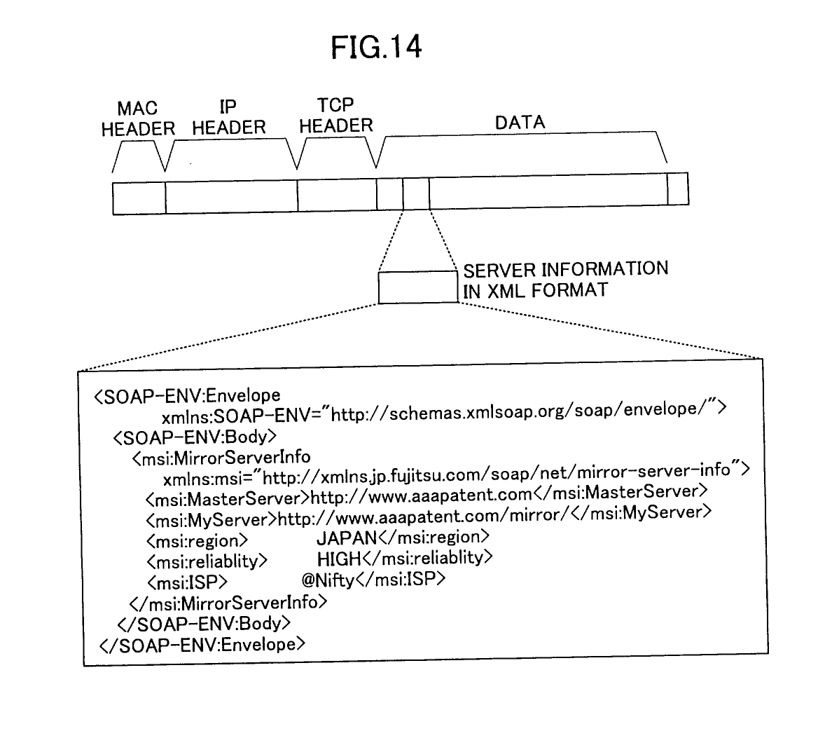

FIG. 14 shows an embodiment of a server information notification packet sent by the server 16-18. The server information notification packet includes a MAC header, an IP header, a TCP header and data. Server information in the data indicates the following information in XML format as shown in the figure. Lines 4 and 5 “<msi:MirrorServerInfo . . . ” declares that this packet is a server information notification packet. Lines 6 and 7 indicate URL information, line 8 indicates that the metric (area information) is Japan, line 9 indicates that the metric (reliability) is high, and line 10 indicates that the metric (@Nifty information) is an ISP (Internet Service Provider) of @Nifty.

The server information can be obtained in another way. That is, each of the servers 16-18 stores server information of itself in an area specified by a URL, and the relay apparatus 14 obtains the server information by performing “HTTP get” for the URL of the server in the same way as transferring a communication packet. In this case, new functions such as the packet discrimination part 35 and the server information storing part 37 become unnecessary in the server.

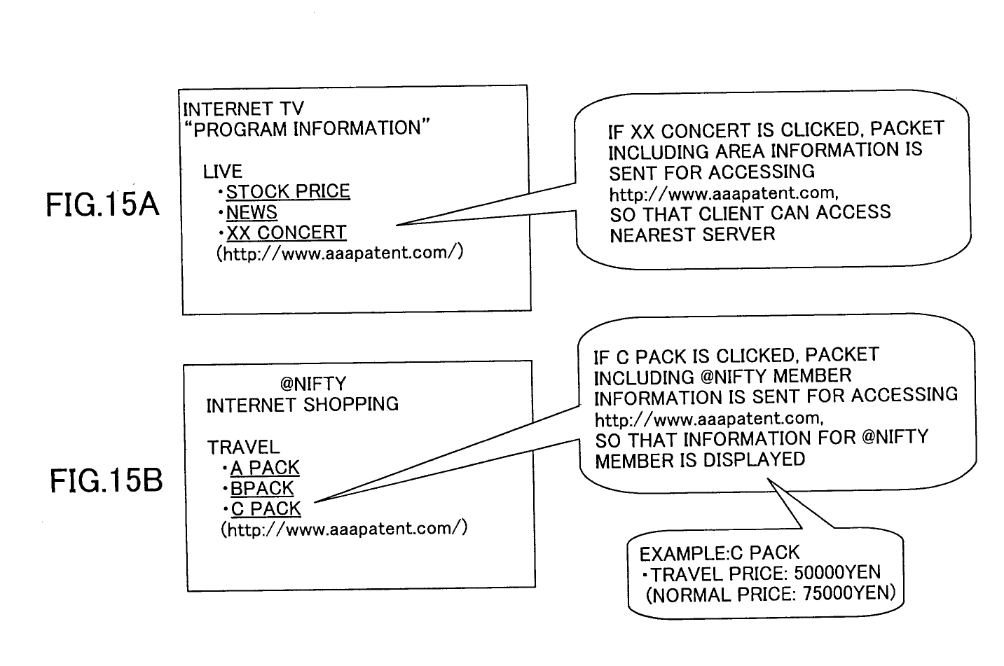

FIGS. 15A and 15B show display screens of the client 10. As shown in FIG. 15A, a menu screen of an Internet TV is displayed on the client 10. When “XX concert” is selected by clicking it, a packet, of an XML format, that includes a metric (area information) indicating the location of the client 10 is automatically generated by a user application in order to access the URL “http://www.aaapatent.com/” corresponding to “XX concert”, and this packet is sent from the client 10. As a result, the client can access the nearest server, so that the user can view a concert near the location of the client 10.

In another case shown in FIG. 15B, a menu screen of travel is displayed. When “C pack” is selected by clicking it, a packet, of an XML format, that includes a metric (@Nifty information) indicating that the user is a member of @Nifty is automatically generated by a user application in order to access the URL “http://www.aaapatent.com/” corresponding to “C pack”, and this packet is sent from the client 10. As a result, a reduced price for the @Nifty member and a normal price are displayed.

In the embodiment shown in FIG. 1, the servers 16 and 17 exist under the relay apparatus 14. However, the present invention can be applied to a configuration without the servers. In addition, the relay apparatus and the client 10 may exist in the same site.

As mentioned above, the client 10 can specify metrics (geographical location, reliability, ISP member and the like) for each packet for the server distribution algorithm. Thus, the geographically nearest server, the most reliable server, the server of shortest response time, the server in which the number of the established sessions is smallest or the like can be selected. In addition, the client can access the nearest server even when allocated IP addresses do not correspond to geographical locations.

In addition, by including information on the ISP to which the user subscribes in the packet, the server or URL to be accessed can be changed according to the ISP. For example, if the user is an @Nifty member, when clicking a button for buying a product at an Internet shopping site of @Nifty, an application form without sections for address and telephone number can be displayed, and an announcement only for @Nifty members and a reduced price can be displayed.

As mentioned above, according to the present invention, a desired metric for the user is included in a communication packet in the client, and the communication packet is sent. Thus, the relay apparatus that receives the communication packet can select an optimal server for the client on the basis of the metric, so that optimal packet distribution can be achieved.

Since the server table is automatically updated by collecting server information from a plurality of servers at predetermined intervals, work load for entering data can be saved and data entry error can be decreased, and the newest information can always be stored in the server table.

The present invention is not limited to the specifically disclosed embodiments, and variations and modifications may be made without departing from the scope of the invention.

What is claimed is:

1. A relay method comprising the steps of:
a relay apparatus receiving a communication packet including a metric from a client;
selecting an optimal server on the basis of said metric by referring to a server table including server information including metrics of servers;
sending said communication packet to a destination server indicated by said communication packet when said destination server is said optimal server;
sending, to said client, a destination changing packet for changing said destination server to said optimal server when said destination server is different from said optimal server.

2. The relay method as claimed in claim 1, further comprising the step of updating said server table by collecting server information from a plurality of servers at predetermined intervals.

3. A relay apparatus comprising:
a server table including server information including metrics of a plurality of servers;
a selection part for selecting an optimal server on the basis of a metric included in a communication packet received from a client by referring to said server table;
a relay part for sending said communication packet to a destination server indicated by said communication packet when said destination server is said optimal server;
a destination changing part for sending, to said client, a destination changing packet for changing said destination server to said optimal server when said destination server is different from said optimal server.

4. The relay apparatus as claimed in claim 3, further comprising a server table updating part for updating said server table by collecting server information from a plurality of servers at predetermined intervals.

5. A client comprising:
a metric specifying part for setting a metric in a communication packet; and
a sending part for sending said communication packet including said metric.

6. A server comprising:
a storing part for storing server information including a metric of said server itself; and
a server information notification part for sending said server information to a relay apparatus.
